(19) United States
(12) Patent Application Publication
(10) Pub. No.: US 2016/0363162 A1
(43) Pub. Date: Dec. 15, 2016

(54) Hollow Ball Stud

(71) Applicant: Rockford Products LLC, Rockford, IL (US)

(72) Inventors: David Richeson, Rockford, IL (US); John Pierce, Stillman Valley, IL (US)

(21) Appl. No.: 15/179,636

(22) Filed: Jun. 10, 2016

Related U.S. Application Data
(60) Provisional application No. 62/174,975, filed on Jun. 12, 2015.

(51) Int. Cl. F16C 11/06

(52) U.S. Cl. CPC F16C 11/0604; F16C 11/0666

(57) ABSTRACT

A ball stud is disclosed that includes a shank, a head, a hollow center, a first cluster of radial holes, and a second cluster of radial holes. The head is formed integrally with the shank or as a single-piece construction with the shank. The hollow center extends at least partially through the shank and at least partially into the head. The first cluster of radial holes is formed into the head. The second cluster of radial holes is formed into the shank.

### CROSS REFERENCE TO RELATED APPLICATIONS

This U.S. patent application claims priority under 35 U.S.C. §119(e) to U.S. Provisional Application 62/174,975, filed on Jun. 12, 2015. The disclosure of this prior application is considered part of the disclosure of this application and is hereby incorporated by reference in its entirety.

### TECHNICAL FIELD

This disclosure generally relates to automotive applications and, more specifically, to ball studs for automotive applications and methods for manufacturing thereof.

### BACKGROUND

Ball-and-socket joints are formed with a joint casing defining a ball cavity and a ball stud having head residing within the ball cavity. While other types of joints may limit the range of motion between the joined components, a ball-and-socket joint permits multi-planar pivoting between the joined components. To this end, ball-and-socket joints are ideal for many applications, especially for automotive applications such as the suspension and steering systems. Virtually every automotive vehicle utilizes multiple ball-and-socket joints, each of which requires a ball stud.

Both consumers and manufacturers desire increases in the fuel efficiency of automotive vehicles. Because the overall weight of the automotive vehicles is directly proportional to the fuel efficiency and consumers have been hesitant to accept compact vehicles or to sacrifice weight-adding features within the cabin of the vehicle, weight reduction of automotive systems has been at the forefront of automotive innovation.

### SUMMARY

One aspect of the disclosure provides a ball stud including a shank, a head, a hollow center, a first cluster of radial through-holes and a second cluster of radial through-holes. The head is formed integrally with the shank or as a single-piece construction with the shank. The hollow center extends at least partially through the shank and at least partially into the head. The first cluster of radial through-holes is formed into the head. The second cluster of radial through-holes is formed into the shank.

Implementations of the disclosure may include one or more of the following features. In some implementations, the shank is substantially cylindrical. The shank may include a tapered portion and a threaded end. In some implementations, the head is substantially spherical. The head may include a flat end.

In some implementations, the radial through-holes of the second cluster are formed with equal spacing around the full circumference of the shank. The second cluster of radial through-holes may include thirty-two through-holes. The first cluster of radial through-holes may include fifty through-holes.

Another aspect of the disclosure provides a method of manufacturing a ball stud that includes cold-forming a blank, heat treating the blank, roll-threading the blank to form a threaded end, and turning the blank to finish the ball stud. The ball stud includes a shank, a head, and a hollow center. The head is formed integrally with the shank or as a single-piece construction with the shank. The hollow center extends at least partially through the shank and at least partially into the head. The shank, the head, and the hollow center begin taking a shape during the cold-forming step. The turning step comprises drill-processing the blank to form a first cluster of radial through-holes formed into the head and a second cluster of radial through-holes formed into the shank.

Implementations of the disclosure may include one or more of the following features. In some implementations, the shank is substantially cylindrical. The shank may include a tapered portion and a threaded end. In some implementations, the head is substantially spherical. The head may include a flat end.

In some implementations, the radial through-holes of the second cluster are formed with equal spacing around the full circumference of the shank. The second cluster of radial through-holes may include thirty-two through-holes. The first cluster of radial through-holes may include fifty through-holes.

Yet another aspect of the disclosure provides a ball stud including a shank, a head, a hollow center, and a plurality of weight-reducing cylindrical holes formed into the ball stud. The head is formed integrally with the shank or as a single-piece construction with the shank. The hollow center extends at least partially through the shank and at least partially into the head.

Implementations of the disclosure may include one or more of the following features. In some implementations, the shank is substantially cylindrical. The shank may include a tapered portion and a threaded end. In some implementations, the head is substantially spherical. The head may include a flat end.

In some implementations, the plurality of weight-reducing cylindrical holes includes holes formed radially into the shank. In some implementations, the plurality of weight-reducing cylindrical holes comprises holes formed radially into the head.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a perspective view of an example ball stud in accordance with the design of this disclosure having a cluster of through-holes.

FIG. 2 is a front view at the head of the ball stud of FIG. 1.

FIG. 3 is a side view of the ball stud of FIG. 1.

FIG. 4 is cross-sectional view along cut 4-4 of FIG. 2 of the ball stud of FIG. 1.

FIG. 5 is a perspective view of an example ball stud in accordance with the design of this disclosure having a first cluster of through-holes and a second cluster of through-holes.

FIG. 6 is a front view at the head of the ball stud of FIG. 5.

FIG. 7 is a side view of the ball stud of FIG. 5.

FIG. 8 is a cross-sectional view along cut 8-8 of FIG. 6 of the ball stud of FIG. 5.

FIGS. 9-10 are schematic views presenting an exemplary arrangement of operations for manufacturing a ball stud.

FIGS. 11A-11B are cross-sectional views cut through exemplary automotive systems utilizing the ball stud of this disclosure.

Like reference symbols in the various drawings indicate like elements.

### DETAILED DESCRIPTION

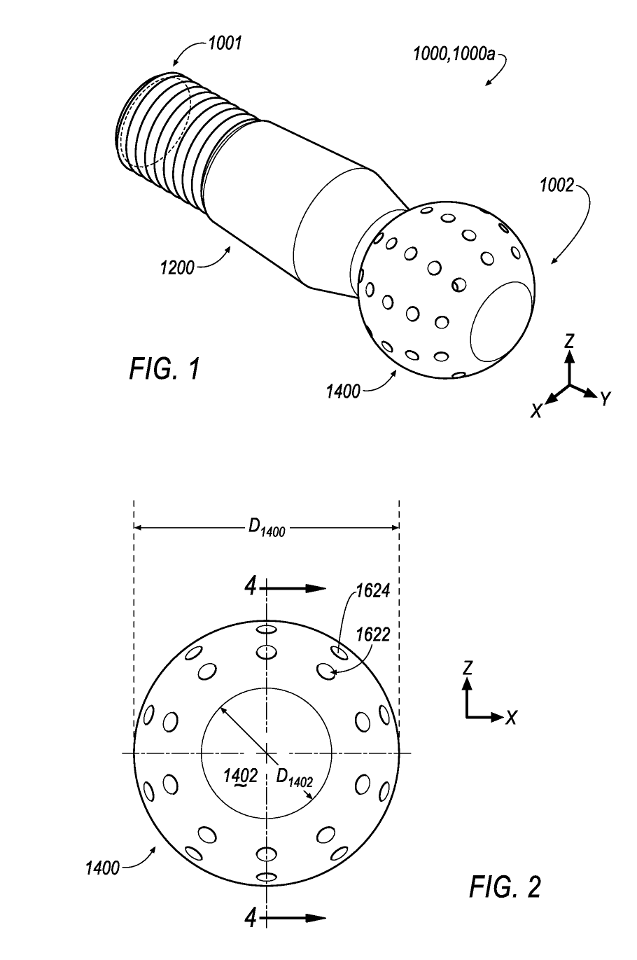

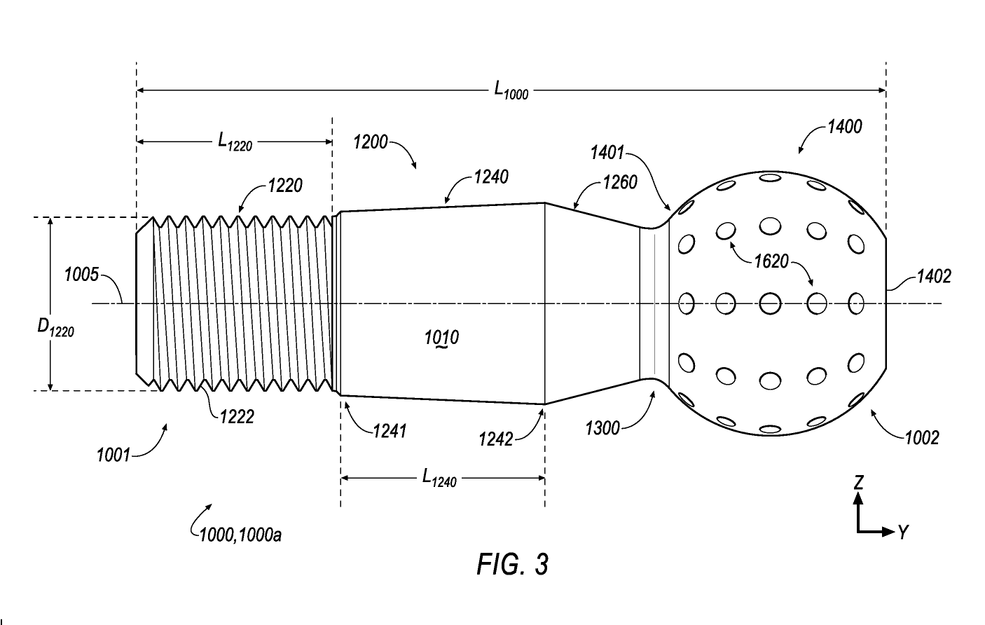

Referring to FIGS. 1-4, in some implementations, the ball stud 1000 of the present disclosure is implemented as a ball stud 1000a having a first cluster 1620 of through-holes 1622. The length L₁₀₀₀ of the ball stud 1000a extends from a first end 1001 to a second end 1002 along a Y-directional longitudinal axis 1005 of the ball stud 1000a. In some implementations, the ball stud 1000a has a length L₁₀₀₀ equal to 6.75-inches. However, the length L₁₀₀₀ of the ball stud 1000a may vary between implementations of the ball stud 1000a. For example, in other implementations, the length L₁₀₀₀ of the ball stud 1000a may be more than 6.75-inches or may be less than 6.75-inches as necessary to conform to the requirements of the particular application for which the ball stud 1000a is utilized.

The ball stud 1000a includes a shank 1200, a head 1400, and a hollow center 1600. The shank 1200 of the ball stud 1000a connects to the head 1400 of the ball stud 1000a at a peripheral groove 1300 formed into the ball stud 1000a. The shank 1200 and the head 1400 of the ball stud 1000a are formed integrally or are formed with a single-piece construction in some other fashion. However, the ball stud 1000a may have a two-piece construction with the shank 1200 and the head 1400 mechanically connected without deviating from the scope of this disclosure.

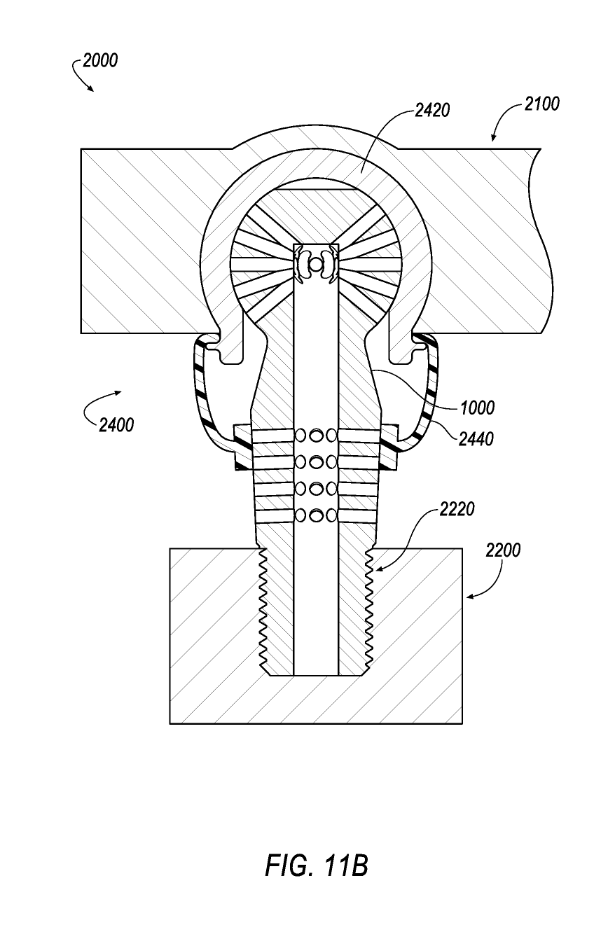

The shank 1200 includes a threaded end 1220, a tapered portion 1240, and a transition section 1260. The threaded end 1220 of the shank 1200 is arranged at the first end 1001 of the ball stud 1000a. The design of the threaded end 1220 may enable the ball stud 1000a to thread into another component (such as the second component 2200 of FIG. 11B) of the automotive system (such as automotive system 2000 of FIG. 11B) in which the ball stud 1000a is utilized, or the threaded end 1220 may accept a nut 2600 (shown, for example, in FIG. 11A) to fasten the first end 1001 of the ball stud 1000a to another component (such as the second component 2200 of FIG. 11A) at an eyelet opening 2240 (shown, for example, in FIG. 11A). In some implementations, the threads 1222 of the threaded end 1220 are sized at thirty-nine-millimeters in accordance with the metric thread size M39×1.5 as defined by the International Organization for Standardization (ISO). However, the threads 1222 of the threaded end 1220 may be implemented as having different thread sizes to conform to the particular application for which the ball stud 1000a is utilized.

In some implementations, the major diameter D₁₂₂₀, measured between the peripheries of the threads 1222, of the threaded end 1220 is between 38.73-millimeters and 38.97-millimeters in accordance with ISO metric thread size M39×1.5. However, the major diameter D₁₂₂₀ may be implemented at different measurements to conform to the particular application for which the ball stud 1000a is utilized. The length L₁₂₂₀ of the threaded end 1220, along which the threads 1222 extend, may vary between implementations of the ball stud 1000a in order to conform to the particular application for which the ball stud 1000a is utilized.

The tapered portion 1240 of the shank 1200 is formed adjacent to the threaded end 1220 of the shank 1200 and extends from a first end 1241 at the threaded end 1220 of the shank 1200 to a second end 1242 at the transition section 1260 of the shank 1200. The tapered portion 1240 has a maximum diameter in the x-z plane about the longitudinal axis 1005 at its second end 1242. To form a tapered shape of the tapered portion 1240 of the shank 1200, the diameter in the x-z plane about the longitudinal axis 1005 of the tapered portion 1240 gradually decreases from its maximum at the second end 1242 of the tapered portion 1240 to its minimum diameter at the first end 1241 of the tapered portion 1240. As the tapered portion 1240 tapers to a minimum diameter at the first end 1241 of the tapered portion 1240, the diameter of the tapered portion 1240 approaches the major diameter D₁₂₂₀ of the threaded end 1220. Each of the minimum diameter of the tapered portion 1240 at the first end 1241, the maximum diameter of the tapered portion 1240 at the second end 1242, and the length L₁₂₄₀ of tapered portion 1240 may vary between implementations of the ball stud 1000a in order to conform to the particular application for which the ball stud 1000a is utilized.

The transition section 1260 of the shank 1200 extends from the second end 1242 of the tapered portion 1240 of the shank 1200 to the peripheral groove 1300. The transition section 1260 of the shank 1200 is formed to enable a one-piece or integral construction of the shank 1200 and the head 1400 of the ball stud 1000a. The transition section 1260 may include a tapered shape having a maximum diameter in the x-z plane about the longitudinal axis 1005 at the second end 1242 of the tapered portion 1240. To form the tapered shape of the transition section 1260, the diameter in the x-z plane about the longitudinal axis 1005 of the transition section 1260 gradually decreases from its maximum at the second end 1242 of the tapered portion 1240 to its minimum diameter at the peripheral groove 1300.

The head 1400 of the ball stud 1000a, which is formed substantially spherically about a center point 1405, has a first end 1401 and a second end 1402. The first end 1401, which is adjacent to the peripheral groove 1300 of the ball stud 1000a, is formed to enable a one-piece or integral construction of the shank 1200 and the head 1400 of the ball stud 1000a. The second end 1402 is arranged at the second end 1002 of the ball stud 1000a and may include a flat or planar construct. In some implementations, the head 1400 of the ball stud 1000a has a diameter D₁₄₀₀ equal to 2.375-inches. However, the diameter D₁₄₀₀ of the head 1400 may vary between implementations of the ball stud 1000a. For example, in other implementations, the diameter D₁₄₀₀ of the head 1400 may be more than 2.375-inches or may be less than 2.375-inches as necessary to conform to the requirements of the particular application for which the ball stud 1000a is utilized.

The head 1400 of the ball stud 1000a functions as the ball portion of a ball-and-socket joint 2400 (shown in FIGS. 11A-11B) and is, accordingly, structurally formed to reside and function within the ball cavity of the joint casing 2420 (shown in FIGS. 11A-11B). The first end 1401 of the head 1400 provides a transition from the substantially-spherical head 1400 to the peripheral groove 1300 of the ball stud 1000a. The second end 1402 of the head 1400, which has a diameter D₁₄₀₂ at the surface of the head 1400, is shaped to provide clearance within the joint casing 2420. The diameter D₁₄₀₂ of the second end 1402 is a function of the diameter D₁₄₀₀ of the head and may vary between different implementations of the ball stud 1000a.

The shank 1200 and the head 1400 of the ball stud 1000a may be formed utilizing different materials as necessary to conform to the requirements of the particular application for which the ball stud 1000a is utilized. In some implementations, the shank 1200 and the head 1400 of the ball stud 1000a are formed utilizing a grade 4140 steel alloy as characterized by the American Iron and Steel Institute (AISI) and the Society of Automotive Engineers (SAE). However, other grades of steel, other metal materials, and non-metal materials may be utilized to form the shank 1200 and the head 1400 without deviating from the scope of this disclosure.

If the ball stud 1000 is embodied as a blank solid ball stud (i.e., without the hollow center 1600 and the first cluster 1620 of through-holes 1622 of ball stud 1000a), then the solid weight W_{1000S} of the ball stud 1000 may be approximated by Equation 1:

W_{1000S}=γ_{M}*V₁₀₀₀ (1)

In Equation 1, γ_{M} represents the unit weight (measured in units of weight per units of volume) of the material forming the ball stud 1000 and V₁₀₀₀ represents the total volume of the ball stud 1000. In some examples, the ball stud 1000 is implemented utilizing a material having a unit weight of approximately 0.284 pounds per cubic inch, γ_{M}≈0.284 lb/in³, and is implemented as having a volume of approximately sixteen cubic inches, V₁₀₀₀≈16 in³. In these examples, Equation 1 demonstrates that the solid weight W_{1000S} of the ball stud 1000—if formed as a blank solid—would exceed 4.5-pounds (approximately 4.55-pounds). Notably, as discussed above, both the material and the dimensions of the ball stud 1000 may vary without deviating from the scope of the disclosure. Accordingly, the unit weight γ_{M}, the volume V₁₀₀₀, and the solid weight W_{1000S} of a blank solid ball stud 1000 may vary from what is discussed here without deviating from the scope of this disclosure.

Notably, the ball stud 1000a of FIGS. 1-4, does not have a gross weight W₁₀₀₀ₐ conforming to the solid weight W_{1000S} of Equation 1 because the ball stud 1000a is not formed as a blank solid ball stud 1000. The ball stud 1000a includes the hollow center 1600 and a first cluster 1620 of through-holes 1622. The hollow center 1600 of the ball stud 1000a may be defined by a bore 1020 extending along a Y-directional length L₁₆₀₀ from an opening 1601 at the first end 1001 of the ball stud 1000a to a second end 1602 of the hollow center 1600. In some implementations, the bore 1020 may include a substantially cylindrical shape having a diameter D₁₆₀₀. The opening 1601 may further include the diameter D₁₆₀₀ and may provide access into the hollow center 1600 at the first end 1001 of the ball stud 1000a. The diameter D₁₆₀₀ of the hollow center 1600 is limited by the diameter D₁₂₂₀ of the threaded end 1220 of the shank 1200 and by manufacturing considerations relating to the formation of the hollow center 1600 by a roll-threading operation (as discussed further hereinafter) while maintaining the threads 1222 on the threaded end 1220 of the shank 1200 at the desired thread specification. In some implementations—for example, when the threads 1222 of the threaded end 1220 are sized at thirty-nine-millimeters in accordance with the ISO metric thread size M39×1.5—the hollow center 1600 of the ball stud 1000a may have a diameter D₁₆₀₀ equal to 0.63-inches. However, the diameter D₁₆₀₀ of the hollow center 1600 may vary between implementations of the ball stud 1000a. For example, in other implementations, the diameter D₁₆₀₀ of the hollow center 1600 may be more than 0.63-inches or may be less than 0.63-inches as necessary to conform to the requirements of the particular application for which the ball stud 1000a is utilized.

The diameter D₁₆₀₀ of the hollow center 1600 remains constant along the full length L₁₆₀₀ of the hollow center 1600 from the opening 1601 to the second end 1602. However, the diameter D₁₆₀₀ of the hollow center 1600 may vary along the length L₁₆₀₀ of the hollow center 1600 without deviating from the scope of this disclosure.

The second end 1602 of the hollow center 1600 terminates the hollow portion of the ball stud 1000a. The second end 1602 of the hollow center 1600 is located between the center point 1405 of the head 1400 and the second end 1402 of the head 1400. However, in other implementations, the second end 1602 of the hollow center 1600 may be at a different location along the length L₁₀₀₀ of the ball stud 1000a, resulting in a longer or a shorter length L₁₆₀₀ of the hollow center 1600, without deviating from the scope of this disclosure. In one alternate implementation, the second end 1602 of the hollow center 1600 is located at the second end 1002 of the ball stud 1000a (L₁₀₀₀=L₁₆₀₀) and forms an opening at the second end 1402 of the head 1400.

If the ball stud 1000 is embodied as a ball stud 1000 with a hollow center 1600 but without a first cluster 1620 of through-holes 1622, then the adjusted weight W_{1000H} of the ball stud 1000 may be approximated by Equation 2:

W_{1000H}=W_{1000S}−WR₁₆₀₀ (2)

In Equation 2, W_{1000S} represents the solid weight of a blank solid ball stud, as calculated utilizing Equation 1, and WR₁₆₀₀ represents the weight reduction attributed to the hollow center 1600. The weight reduction WR₁₆₀₀ attributed to the hollow center 1600 may be approximated by Equation 3:

WR₁₆₀₀=γ_{M}*L₁₆₀₀*π*(0.5*D₁₆₀₀)² (3)

In some examples, the ball stud 1000 is implemented utilizing a material having a unit weight of approximately 0.284 pounds per cubic inch, γ_{M}≈0.284 lb/in³, and is implemented as having a solid weight W_{1000S}≈4.55 lb. (as demonstrated in the previously described example), an L₁₆₀₀≈5.5 inches, and a D₁₆₀₀≈0.63 inches. In these examples, Equation 3 demonstrates that the weight reduction WR₁₆₀₀ attributed to the hollow center 1600 approximates 4.87-pounds. Equation 2 then demonstrates that the adjusted weight W_{1000H} approximates 4.06-pounds. Notably, as discussed above, both the material and the dimensions of the ball stud 1000 may vary without deviating from the scope of the disclosure. Accordingly, the unit weight γ_{M}, the weight reduction WR₁₆₀₀ attributed to the hollow center 1600, and the adjusted weight W_{1000H} may vary from what is discussed here without deviating from the scope of this disclosure.

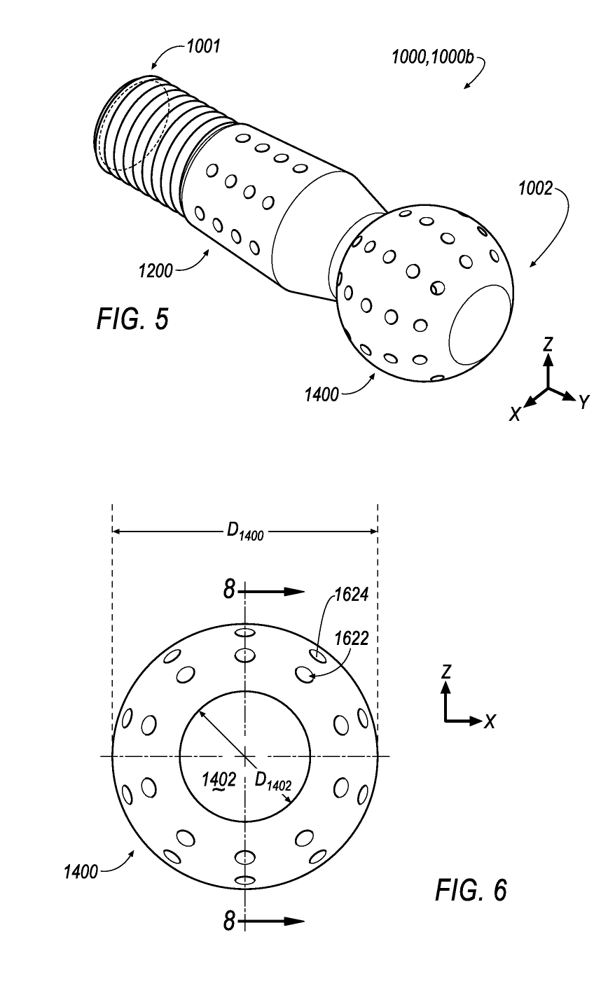

Notably, the ball stud 1000a of FIGS. 1-4 does not have a gross weight W₁₀₀₀ₐ conforming to the adjusted weight W_{1000H} demonstrated by Equation 2 because the ball stud 1000a has its weight further reduced by the first cluster 1620 of through-holes 1622. The first cluster 1620 of through-holes 1622 is formed into the head 1400 of the ball stud 1000a. The first cluster 1620 of through-holes 1622 includes an integer number, n, of through-holes 1622. Each through-hole 1622₁, 1622₂, . . . 1622ₙ of the cluster 1620 of through-holes 1622 radially extends from an opening 1626₁, 1626₂, . . . 1626ₙ at the hollow center 1600 to an opening 1624₁, 1624₂, . . . 1624ₙ at the outer surface of the head 1400 of the ball stud 1000a. Each of the integer number, n, of through-holes 1622₁, 1622₂, . . . 1622ₙ is arranged along a radial line extending from the center point 1405 of the head 1400 of the ball stud 1000a. As illustrated in FIG. 4, each of the integer number, n, of through-holes 1622₁, 1622₂, . . . 1622ₙ may be aligned with another of the integer number, n, of through-holes 1622₁, 1622₂, . . . 1622ₙ along a radially-extending line. In some implementations, the integer number, n, of through-holes 1622 may be implemented as n=50 through-holes 1622₁-1622₅₀. However, the integer number, n, of through-holes 1622 may vary between different implementations of the ball stud 1000a. For example, in other implementations, the integer number, n, of through-holes 1622 may be more than n=50 or may be less than n=50 as necessary to conform to the requirements of the particular application for which the ball stud 1000a is utilized.

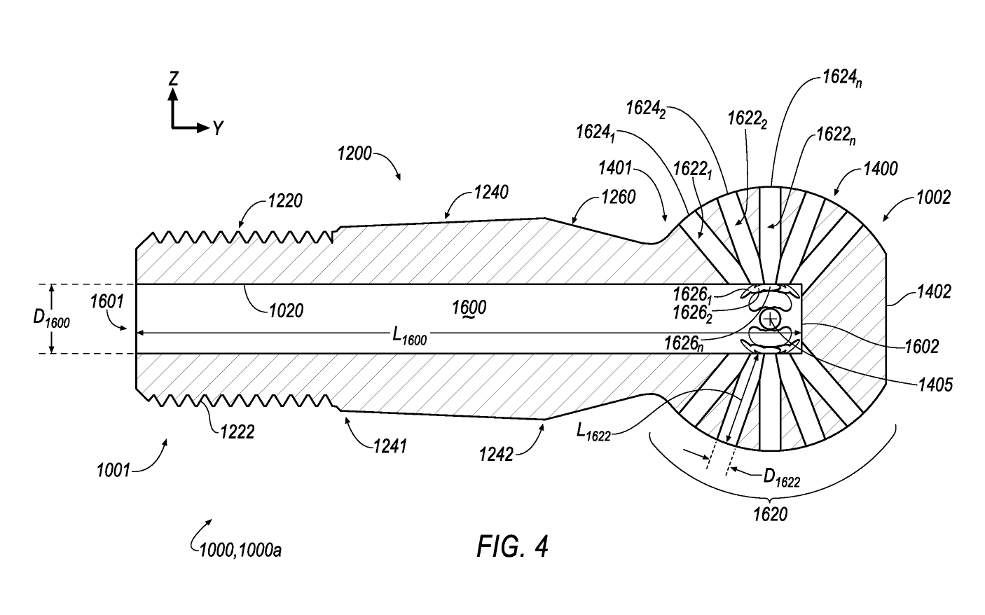

Each of the integer number, n, of through-holes 1622 has a length L₁₆₂₂ extending from an opening 1626₁, 1626₂, . . . 1626ₙ at the hollow center 1600 to an opening 1624₁, 1624₂, . . . 1624ₙ at the outer surface of the head 1400 of the ball stud 1000a. In some implementations, a plurality of through-holes 1622₁, 1622₂, . . . 1622ₙ may extend from a particular one of the openings 1626₁, 1626₂, . . . 1626ₙ. For example, as illustrated in FIG. 4, five through-holes 1622₁, 1622₂, . . . 1622ₙ may extend from a particular one of the openings 1626₁, 1626₂, . . . 1626ₙ. As illustrated in FIG. 3, the plurality of through-holes 1622₁, 1622₂, . . . 1622ₙ extending from a particular one of the openings 1626₁, 1626₂, . . . 1626ₙ may be aligned in an axially-extending direction (i.e., in a direction extending substantially parallel to the longitudinal axis 1005. The length L₁₆₂₂ of each of the integer number, n, of through-holes 1622 extends along a radially-extending line between the center point 1405 of the head 1400 and the outer surface of the head 1400. The length L₁₆₂₂ of some of the through-holes 1622 may vary slightly from the length L₁₆₂₂ of other through-holes 1622 (i.e., the L₁₆₂₂ of through-hole 1622₁ may vary from the length L₁₆₂₂ of through-hole 1622₂). An average length AVG(L₁₆₂₂) of the through-holes 1622 may be calculated by summing the lengths L₁₆₂₂ of each through-hole 1622₁-1622ₙ and dividing the sum by the integer number, n.

In some implementations, each of the integer number, n, of through-holes 1622₁, 1622₂, . . . 1622ₙ has a constant diameter D₁₆₂₂ from the opening 1626₁, 1626₂, . . . 1626ₙ at the hollow center 1600 to the opening 1624₁, 1624₂, . . . 1624ₙ at the outer surface of the head 1400 of the ball stud 1000a. However, in other implementations, the diameter D₁₆₂₂ of one or more of the through-holes 1622 may vary along the length L₁₆₂₂ of the through-hole 1622 from the opening 1626 at the hollow center 1600 to the opening 1624 at the outer surface of the head 1400.

In some implementations, the constant diameter D₁₆₂₂ of each of the integer number, n, through-holes 1622₁, 1622₂, . . . 1622ₙ is equal (i.e., D₁₆₂₂ of 1622₁=D₁₆₂₂ of 1622₂= . . . =D₁₆₂₂ of 1622ₙ). However, in other implementations, the diameter D₁₆₂₂ of any given through-hole 1622 may differ from the diameter D₁₆₂₂ of any other through-hole 1622. Both the diameter D₁₆₂₂ of the through-holes 1622 and the integer number, n, of through-holes 1622 are both limited by the diameter D₁₄₀₀ of the head 1400 of the particular implementations of the ball stud 1000a. For any given diameter D₁₄₀₀ of the head 1400, the diameter D₁₆₂₂ of the through-holes 1622 and the integer number, n, of through-holes 1622 are limited in order to maintain the strength and integrity of the ball stud 1000a.

Because each through-holes 1622₁, 1622₂, . . . 1622ₙ of the first cluster 1620 of through-holes 1622 is formed from the hollow center 1600 to the outer surface of the head 1400 of the ball stud 1000a, each opening 1624₁, 1624₂, . . . 1624ₙ at the outer surface of the head 1400 of the ball stud 1000a is in fluid communication with the opening 1601 at the first end 1001 of the ball stud 1000a. Accordingly, when the ball stud 1000a is installed in a ball-and-socket joint 2400 that is fluidly sealed by a seal 2440 (as illustrated in FIGS. 11A-11B), fluid access to the sealed ball-and-socket joint 2400 is provided by the opening 1601 at the first end 1001 of the ball stud 1000a fluidly communicating with the openings 1624 at the outer surface of the head 1400 of the ball stud 1000a. A fluid, such as a lubricating fluid, may enter the sealed ball-and-socket joint 2400 utilizing the hollow center 1600 of the ball stud 1000a and the first cluster 1620 of through-holes 1622.

A gross weight W₁₀₀₀ₐ of the ball stud 1000a may be approximated by Equation 4:

W₁₀₀₀ₐ=W_{1000H}−WR₁₆₂₀ (4)

In Equation 4, W_{1000H} represents the adjusted weight of a ball stud with a hollow center 1600 but without a first cluster 1620 of through-holes 1622, as calculated utilizing Equation 2, and WR₁₆₂₀ represents the weight reduction attributed to the first cluster 1620 of through-holes 1622. The weight reduction WR₁₆₂₀ attributed to the first cluster 1620 of through-holes 1622 may be approximated by Equation 5:

WR₁₆₂₀=n*γ_{M}*AVG(L₁₆₂₂)*π*(0.5*D₁₆₂₂)² (5)

In some examples, the ball stud 1000 is implemented utilizing a material having a unit weight of approximately 0.284 pounds per cubic inch, γ_{M}≈0.284 lb/in³, and is implemented as having an adjusted weight W_{1000H}≈4.06 lb. (as demonstrated in the previously described example), an AVG(L₁₆₂₂)≈0.95-inches, a D₁₆₂₂≈0.177-inches, and an integer n=50. In these examples, Equation 5 demonstrates that the weight reduction WR₁₆₂₀ attributed to the first cluster 1620 of through-holes 1622 approximates 0.33-pounds. Equation 3 then demonstrates that the gross weight W₁₀₀₀ₐ approximates 3.72-pounds. This represents a gross weight reduction of eighteen percent (0.83-pounds) in the ball stud 1000a when compared to the blank solid weight W_{1000S}. Notably, as discussed above, both the material and the dimensions of the ball stud 1000a may vary without deviating from the scope of the disclosure. Accordingly, the unit weight γ_{M}, the weight reduction WR₁₆₂₀ attributed to the first cluster 1620 of through-holes 1622, the gross weight W₁₀₀₀ₐ, and the gross weight reduction may vary from what is discussed here without deviating from the scope of this disclosure.

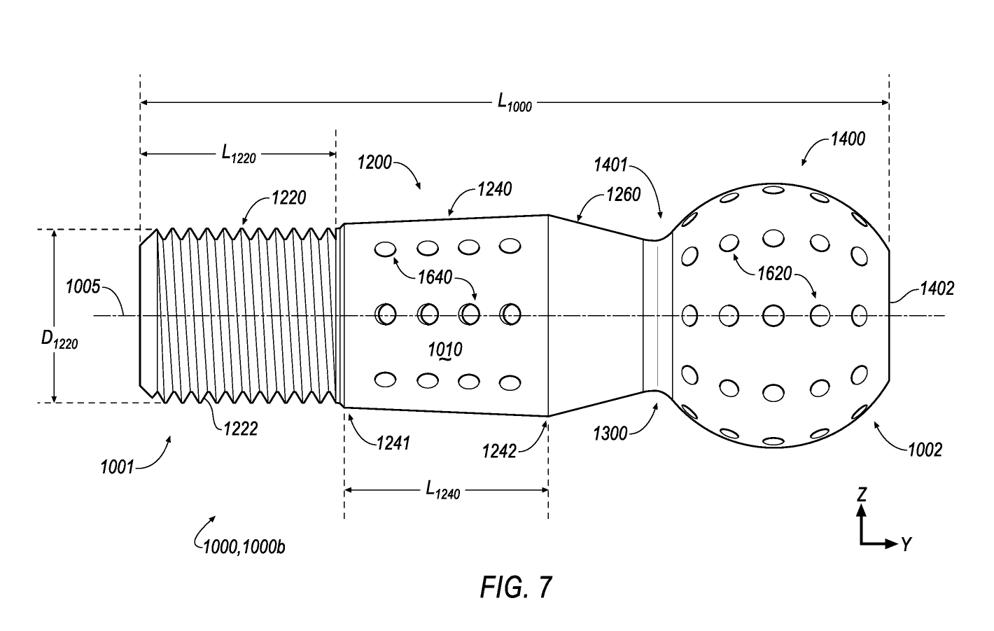

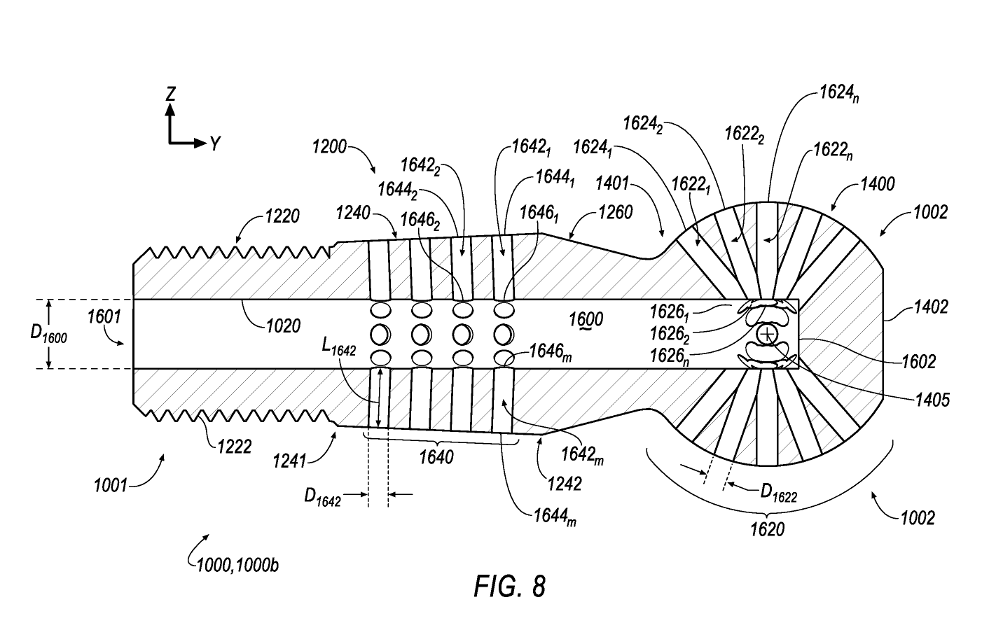

Referring to FIGS. 5-8, in some implementations, the ball stud 1000 of the present disclosure is implemented as a ball stud 1000b having a first cluster 1620 of through-holes 1622 and a second cluster 1640 of through-holes 1642. The length L₁₀₀₀ of the ball stud 1000b extends from a first end 1001 to a second end 1002 along a Y-directional longitudinal axis 1005 of the ball stud 1000b. In some implementations, the ball stud 1000b has a length L₁₀₀₀ equal to 6.75-inches. However, the length L₁₀₀₀ of the ball stud 1000b may vary between implementations of the ball stud 1000b. For example, in other implementations, the length L₁₀₀₀ of the ball stud 1000b may be more than 6.75-inches or may be less than 6.75-inches as necessary to conform to the requirements of the particular application for which the ball stud 1000b is utilized.

The ball stud 1000b includes a shank 1200, a head 1400, and a hollow center 1600. The shank 1200 of the ball stud 1000b connects to the head 1400 of the ball stud 1000b at a peripheral groove 1300 formed into the ball stud 1000b. The shank 1200 and the head 1400 of the ball stud 1000b are formed integrally or are formed with a single-piece construction in some other fashion. However, the ball stud 1000b may have a two-piece construction with the shank 1200 and the head 1400 mechanically connected without deviating from the scope of this disclosure.

The shank 1200 includes a threaded end 1220, a tapered portion 1240, and a transition section 1260. The threaded end 1220 of the shank 1200 is arranged at the first end 1001 of the ball stud 1000b. The design of the threaded end 1220 may enable the ball stud 1000b to thread into another component (such as the second component 2200 of FIG. 11B) of the automotive system (such as automotive system 2000 of FIG. 11B) in which the ball stud 1000b is utilized, or the threaded end 1220 may accept a nut 2600 (shown, for example, in FIG. 11A) to fasten the first end 1001 of the ball stud 1000b to another component (such as the second component 2200 of FIG. 11A) at an eyelet opening 2240 (shown, for example, in FIG. 11A). In some implementations, the threads 1222 of the threaded end 1220 are sized at thirty-nine-millimeters in accordance with the metric thread size M39×1.5 as defined by the International Organization for Standardization (ISO). However, the threads 1222 of the threaded end 1220 may be implemented as having different thread sizes to conform to the particular application for which the ball stud 1000b is utilized.

In some implementations, the major diameter D₁₂₂₀, measured between the peripheries of the threads 1222, of the threaded end 1220 is between 38.73-millimeters and 38.97-millimeters in accordance with ISO metric thread size M39×1.5. However, the major diameter D₁₂₂₀ may be implemented at different measurements to conform to the particular application for which the ball stud 1000b is utilized. The length L₁₂₂₀ of the threaded end 1220, along which the threads 1222 extend, may vary between implementations of the ball stud 1000b in order to conform to the particular application for which the ball stud 1000b is utilized.

The tapered portion 1240 of the shank 1200 is formed adjacent to the threaded end 1220 of the shank 1200 and extends from a first end 1241 at the threaded end 1220 of the shank 1200 to a second end 1242 at the transition section 1260 of the shank 1200. The tapered portion 1240 has a maximum diameter in the x-z plane about the longitudinal axis 1005 at its second end 1242. To form a tapered shape of the tapered portion 1240 of the shank 1200, the diameter in the x-z plane about the longitudinal axis 1005 of the tapered portion 1240 gradually decreases from its maximum at the second end 1242 of the tapered portion 1240 to its minimum diameter at the first end 1241 of the tapered portion 1240. As the tapered portion 1240 tapers to a minimum diameter at the first end 1241 of the tapered portion 1240, the diameter of the tapered portion 1240 approaches the major diameter D₁₂₂₀ of the threaded end 1220. Each of the minimum diameter of the tapered portion 1240 at the first end 1241, the maximum diameter of the tapered portion 1240 at the second end 1242, and the length L₁₂₄₀ of tapered portion 1240 may vary between implementations of the ball stud 1000b in order to conform to the particular application for which the ball stud 1000b is utilized.

The transition section 1260 of the shank 1200 extends from the second end 1242 of the tapered portion 1240 of the shank 1200 to the peripheral groove 1300. The transition section 1260 of the shank 1200 is formed to enable a one-piece or integral construction of the shank 1200 and the head 1400 of the ball stud 1000b. The transition section 1260 may include a tapered shape having a maximum diameter in the x-z plane about the longitudinal axis 1005 at the second end 1242 of the tapered portion 1240. To form the tapered shape of the transition section 1260, the diameter in the x-z plane about the longitudinal axis 1005 of the transition section 1260 gradually decreases from its maximum at the second end 1242 of the tapered portion 1240 to its minimum diameter at the peripheral groove 1300.

The head 1400 of the ball stud 1000b, which is formed substantially spherically about a center point 1405, has a first end 1401 and a second end 1402. The first end 1401, which is adjacent to the peripheral groove 1300 of the ball stud 1000b, is formed to enable a one-piece or integral construction of the shank 1200 and the head 1400 of the ball stud 1000b. The second end 1402 is arranged at the second end 1002 of the ball stud 1000b and may include a flat or planar construct. In some implementations, the head 1400 of the ball stud 1000b has a diameter D₁₄₀₀ equal to 2.375-inches. However, the diameter D₁₄₀₀ of the head 1400 may vary between implementations of the ball stud 1000b. For example, in other implementations, the diameter D₁₄₀₀ of the head 1400 may be more than 2.375-inches or may be less than 2.375-inches as necessary to conform to the requirements of the particular application for which the ball stud 1000b is utilized.

The head 1400 of the ball stud 1000b functions as the ball portion of a ball-and-socket joint 2400 (shown in FIGS. 11A-11B) and is, accordingly, structurally formed to reside and function within the ball cavity of the joint casing 2420 (shown in FIGS. 11A-11B). The first end 1401 of the head 1400 provides a transition from the substantially-spherical head 1400 to the peripheral groove 1300 of the ball stud 1000b. The second end 1402 of the head 1400, which has a diameter D₁₄₀₂ at the surface of the head 1400, is shaped to provide clearance within the joint casing 2420. The diameter D₁₄₀₂ of the second end 1402 is a function of the diameter D₁₄₀₀ of the head and may vary between different implementations of the ball stud 1000b.

The shank 1200 and the head 1400 of the ball stud 1000b may be formed utilizing different materials as necessary to conform to the requirements of the particular application for which the ball stud 1000b is utilized. In some implementations, the shank 1200 and the head 1400 of the ball stud 1000b are formed utilizing a grade 4140 steel alloy as characterized by the American Iron and Steel Institute (AISI) and the Society of Automotive Engineers (SAE). However, other grades of steel, other metal materials, and non-metal materials may be utilized to form the shank 1200 and the head 1400 without deviating from the scope of this disclosure.

As described previously, a solid weight W_{1000S} of a blank solid ball stud (similar to the ball stud 1000b but without a hollow center 1600, a first cluster 1620 of through-holes 1622 or a second cluster 1640 of through-holes 1642) may be determined utilizing Equation 1. Similarly to the previous description, in some examples, the ball stud 1000 is implemented utilizing a material having a unit weight of approximately 0.284 pounds per cubic inch, γ_{M}≈0.284 lb/in³, and is implemented as having a volume of approximately sixteen cubic inches, V₁₀₀₀≈16 in³. In these examples, Equation 1 demonstrates that the solid weight W_{1000S} of the ball stud 1000—if formed as a blank solid—would exceed 4.5-pounds (approximately 4.55-pounds).

Notably, the ball stud 1000b of FIGS. 5-8, does not have a gross weight W_{1000b} conforming to the solid weight W_{1000S} of Equation 1 because the ball stud 1000b is not formed as a blank solid ball stud 1000. The ball stud 1000b includes the hollow center 1600, a first cluster 1620 of through-holes 1622, and a second cluster 1640 of through-holes 1642. The hollow center 1600 of the ball stud 1000b may be defined by a bore 1020 extending along a Y-directional length L₁₆₀₀ from an opening 1601 at the first end 1001 of the ball stud 1000b to a second end 1602 of the hollow center 1600. In some implementations, the bore 1020 may include a substantially cylindrical shape having a diameter D₁₆₀₀. The opening 1601 may further include the diameter D₁₆₀₀ and may provide access into the hollow center 1600 at the first end 1001 of the ball stud 1000b. The diameter D₁₆₀₀ of the hollow center 1600 is limited by the diameter D₁₂₂₀ of the threaded end 1220 of the shank 1200 and by manufacturing considerations relating to the formation of the hollow center 1600 by a roll-threading operation (as discussed further hereinafter) while maintaining the threads 1222 on the threaded end 1220 of the shank 1200 at the desired thread specification. In some implementations—for example, when the threads 1222 of the threaded end 1220 are sized at thirty-nine-millimeters in accordance with the ISO metric thread size M39×1.5—the hollow center 1600 of the ball stud 1000b may have a diameter D₁₆₀₀ equal to 0.63-inches. However, the diameter D₁₆₀₀ of the hollow center 1600 may vary between implementations of the ball stud 1000b. For example, in other implementations, the diameter D₁₆₀₀ of the hollow center 1600 may be more than 0.63-inches or may be less than 0.63-inches as necessary to conform to the requirements of the particular application for which the ball stud 1000b is utilized.

The diameter D₁₆₀₀ of the hollow center 1600 remains constant along the full length L₁₆₀₀ of the hollow center 1600 from the opening 1601 to the second end 1602. However, the diameter D₁₆₀₀ of the hollow center 1600 may vary along the length L₁₆₀₀ of the hollow center 1600 without deviating from the scope of this disclosure.

The second end 1602 of the hollow center 1600 terminates the hollow portion of the ball stud 1000b. The second end 1602 of the hollow center 1600 is located between the center point 1405 of the head 1400 and the second end 1402 of the head 1400. However, in other implementations, the second end 1602 of the hollow center 1600 may be at a different location along the length L₁₀₀₀ of the ball stud 1000b, resulting in a longer or a shorter length L₁₆₀₀ of the hollow center 1600, without deviating from the scope of this disclosure. In one alternate implementation, the second end 1602 of the hollow center 1600 is located at the second end 1002 of the ball stud 1000b (L₁₀₀₀=L₁₆₀₀) and forms an opening at the second end 1402 of the head 1400.

If the ball stud 1000 is embodied as a ball stud 1000 with a hollow center 1600 but without a first cluster 1620 of through-holes 1622 or a second cluster 1640 of through-holes 1642, then the adjusted weight W_{1000H} of the ball stud 1000 may be approximated by above-described Equation 2. In some examples, the ball stud 1000 is implemented utilizing a material having a unit weight of approximately 0.284 pounds per cubic inch, γ_{M}≈0.284 lb/in³, and is implemented as having a solid weight W_{1000S}≈4.55 lb. (as demonstrated in the previously described example), an L₁₆₀₀≈5.5 inches, and a D₁₆₀₀≈0.63 inches. In these examples, above-described Equation 3 demonstrates that the weight reduction WR₁₆₀₀ attributed to the hollow center 1600 approximates 4.87-pounds. Equation 2 then demonstrates that the adjusted weight W_{1000H} approximates 4.06-pounds.

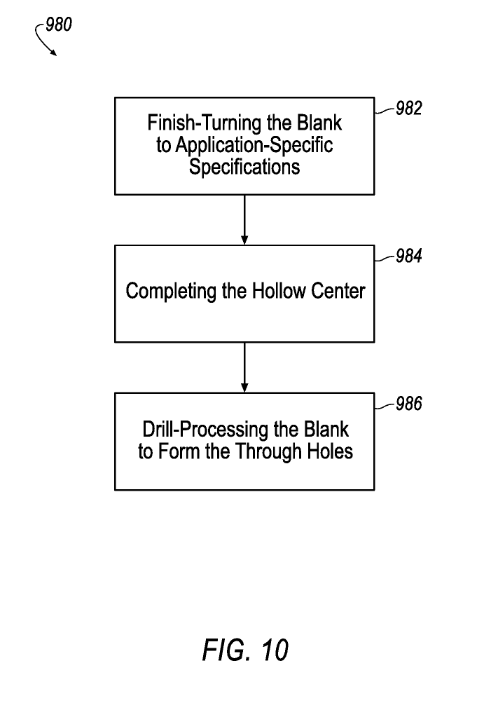

Notably, the ball stud 1000b of FIGS. 5-8 does not have a gross weight W_{1000b} conforming to the adjusted weight W_{1000H} demonstrated by Equation 2 because the ball stud 1000b has its weight further reduced by the first cluster 1620 of through-holes 1622 and the second cluster 1640 of through-holes 1642. The first cluster 1620 of through-holes 1622 is formed into the head 1400 of the ball stud 1000b. The first cluster 1620 of through-holes 1622 includes an integer number, n, of through-holes 1622. Each through-hole 1622₁, 1622₂, . . . 1622ₙ of the cluster 1620 of through-holes 1622 radially extends from an opening 1626₁, 1626₂, . . . 1626ₙ at the hollow center 1600 to an opening 1624₁, 1624₂, . . . 1624ₙ at the outer surface of the head 1400 of the ball stud 1000b. Each of the integer number, n, of through-holes 1622₁, 1622₂, . . . 1622ₙ is arranged along a radial line extending from the center point 1405 of the head 1400 of the ball stud 1000b. As illustrated in FIG. 8, each of the integer number, n, of through-holes 1622₁, 1622₂, . . . 1622ₙ may be aligned with another of the integer number, n, of through-holes 1622₁, 1622₂, . . . 1622ₙ along a radially-extending line. In some implementations, the integer number, n, of through-holes 1622 may be implemented as n=50 through-holes 1622₁-1622₅₀. However, the integer number, n, of through-holes 1622 may vary between different implementations of the ball stud 1000b. For example, in other implementations, the integer number, n, of through-holes 1622 may be more than n=50 or may be less than n=50 as necessary to conform to the requirements of the particular application for which the ball stud 1000b is utilized.

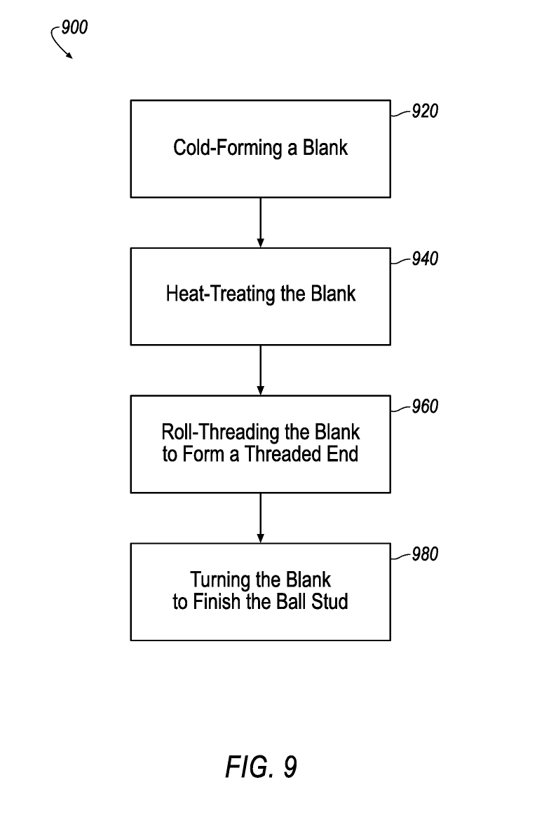

Each of the integer number, n, of through-holes 1622 has a length L₁₆₂₂ extending from an opening 1626₁, 1626₂, . . . 1626ₙ at the hollow center 1600 to an opening 1624ₖ, 1624₂, . . . 1624ₙ at the outer surface of the head 1400 of the ball stud 1000b. In some implementations, a plurality of through-holes 1622₁, 1622₂, . . . 1622ₙ may extend from a particular one of the openings 1626₁, 1626₂, . . . 1626ₙ. For example, as illustrated in FIG. 8, five through-holes 1622₁, 1622₂, . . . 1622ₙ may extend from a particular one of the openings 1626₁, 1626₂, . . . 1626ₙ. As illustrated in FIG. 7, the plurality of through-holes 1622₁, 1622₂, . . . 1622ₙ extending from a particular one of the openings 1626₁, 1626₂, . . . 1626ₙ may be aligned in an axially-extending direction (i.e., in a direction extending substantially parallel to the longitudinal axis 1005. The length L₁₆₂₂ of each of the integer number, n, of through-holes 1622 extends along a radially-extending line between the center point 1405 of the head 1400 and the outer surface of the head 1400. The length L₁₆₂₂ of some of the through-holes 1622 may vary slightly from the length L₁₆₂₂ of other through-holes 1622 (i.e., the L₁₆₂₂ of through-hole 1622₁ may vary from the length L₁₆₂₂ of through-hole 1622₂). An average length AVG(L₁₆₂₂) of the through-holes 1622 may be calculated by summing the lengths L₁₆₂₂ of each through-hole 1622₁-1622ₙ and dividing the sum by the integer number, n.

In some implementations, each of the integer number, n, of through-holes 1622₁, 1622₂, . . . 1622ₙ has a constant diameter D₁₆₂₂ from the opening 1626₁, 1626₂, . . . 1626ₙ at the hollow center 1600 to the opening 1624₁, 1624₂, . . . 1624ₙ at the outer surface of the head 1400 of the ball stud 1000b. However, in other implementations, the diameter D₁₆₂₂ of one or more of the through-holes 1622 may vary along the length L₁₆₂₂ of the through-hole 1622 from the opening 1626 at the hollow center 1600 to the opening 1624 at the outer surface of the head 1400.

In some implementations, the constant diameter D₁₆₂₂ of each of the integer number, n, through-holes 1622₁, 1622₂, . . . 1622ₙ is equal (i.e., D₁₆₂₂ of 1622₁=D₁₆₂₂ of 1622₂= . . . =D₁₆₂₂ of 1622ₙ). However, in other implementations, the diameter D₁₆₂₂ of any given through-hole 1622 may differ from the diameter D₁₆₂₂ of any other through-hole 1622. Both the diameter D₁₆₂₂ of the through-holes 1622 and the integer number, n, of through-holes 1622 are both limited by the diameter D₁₄₀₀ of the head 1400 of the particular implementations of the ball stud 1000b. For any given diameter D₁₄₀₀ of the head 1400, the diameter D₁₆₂₂ of the through-holes 1622 and the integer number, n, of through-holes 1622 are limited in order to maintain the strength and integrity of the ball stud 1000b.

Because each through-holes 1622₁, 1622₂, . . . 1622ₙ of the first cluster 1620 of through-holes 1622 is formed from the hollow center 1600 to the outer surface of the head 1400 of the ball stud 1000b, each opening 1624₁, 1624₂, . . . 1624ₙ at the outer surface of the head 1400 of the ball stud 1000b is in fluid communication with the opening 1601 at the first end 1001 of the ball stud 1000b. Accordingly, when the ball stud 1000b is installed in a ball-and-socket joint 2400 that is fluidly sealed by a seal 2440 (as illustrated in FIGS. 11A-11B), fluid access to the sealed ball-and-socket joint 2400 is provided by the opening 1601 at the first end 1001 of the ball stud 1000b fluidly communicating with the openings 1624 at the outer surface of the head 1400 of the ball stud 1000b. A fluid, such as a lubricating fluid, may enter the sealed ball-and-socket joint 2400 utilizing the hollow center 1600 of the ball stud 1000b and the first cluster 1620 of through-holes 1622.

The second cluster 1640 of through-holes 1642 is formed into the shank 1200 of the ball stud 1000b. The second cluster 1640 of through-holes 1642 includes an integer number, m, of through-holes 1642. Each through-hole 1642₁, 1642₂, . . . 1642ₘ of the second cluster 1640 of through-holes 1642 radially extends from an opening 1646₁, 1646₂, . . . 1646ₘ at the hollow center 1600 to an opening 1644₁, 1644₂, . . . 1644ₙ at the outer surface of the shank 1200 of the ball stud 1000b. Each of the integer number, m, of through-holes 1642₁, 1642₂, . . . 1642ₘ is arranged along a radial line extending from the longitudinal axis 1005 of the ball stud 1000b. Unlike the through-holes 1622 of the first cluster 1620, which each extend along a radially-extending line from a single center point 1405, the through-holes 1642 of the second cluster 1640 extend from more than one point along the longitudinal axis 1005 of the ball stud 1000b. As illustrated in FIG. 7, a plurality of through-holes 1642₁, 1642₂, . . . 1642ₘ may be aligned in an axially-extending direction (i.e., in a direction extending substantially parallel to the longitudinal axis 1005. In particular, a plurality of through-holes 1642₁, 1642₂, . . . 1642ₘ may be aligned with a plurality of through-holes 1622₁, 1622₂, . . . 1622ₙ in the axially-extending direction. In some implementations, the integer number, m, of through-holes 1642 may be implemented as m=32 through-holes 1642₁-1642₃₂. However, the integer number, m, of through-holes 1642 may vary between different implementations of the ball stud 1000b. For example, in other implementations, the integer number, m, of through-holes 1642 may be more than m=50 or may be less than m=50 as necessary to conform to the requirements of the particular application for which the ball stud 1000b is utilized.

Each of the integer number, m, of through-holes 1642 has a length L₁₆₄₂ extending from an opening 1646₁, 1646₂, . . . 1646ₘ at the hollow center 1600 to an opening 1644₁, 1644₂, . . . 1644ₘ at the outer surface of the shank 1200 of the ball stud 1000b. The length L₁₆₄₂ of each of the integer number, m, of through-holes 1642 extends along a radial line between the longitudinal axis 1005 of the ball stud 1000b and the outer surface of the shank 1200. The length L₁₆₄₂ of some of the through-holes 1642 may vary slightly from the length L₁₆₄₂ of other through-holes 1642 (i.e., the L₁₆₄₂ of through-hole 1642₁ may vary from the length L₁₆₄₂ of through-hole 1642₂). An average length AVG(L₁₆₄₂) of the through-holes 1642 may be calculated by summing the lengths L₁₆₄₂ of each through-hole 1642₁-1642ₘ and dividing the sum by the integer number, m.

In some implementations, each of the integer number, m, of through-holes 1642₁, 1642₂, . . . 1642ₘ has a constant diameter D₁₆₄₂ from the opening 1646ₖ, 1646₂, . . . 1646ₘ at the hollow center 1600 to the opening 1644₁, 1644₂, . . . 1644ₘ at the outer surface of the shank 1200 of the ball stud 1000b. However, in other implementations, the diameter D₁₆₄₂ of one or more of the through-holes 1642 may vary along the length L₁₆₄₂ of the through-hole 1642 from the opening 1646 at the hollow center 1600 to the opening 1644 at the outer surface of the shank 1200.

In some implementations, the constant diameter D₁₆₄₂ of each of the integer number, m, through-holes 1642₁, 1642₂, . . . 1642ₘ is equal (i.e., D₁₆₄₂ of 1642₁=D₁₆₄₂ of 1642₂= . . . =D₁₆₄₂ of 1642ₘ). However, in other implementations, the diameter D₁₆₄₂ of any given through-hole 1642 may differ from the diameter D₁₆₄₂ of any other through-hole 1642. Both the diameter D₁₆₄₂ of the through-holes 1642 and the integer number, m, of through-holes 1642 are both limited by the length of the shank 1200 of the particular implementations of the ball stud 1000b. For any given length of the shank 1200, the diameter D₁₆₄₂ of the through-holes 1642 and the integer number, m, of through-holes 1642 are limited in order to maintain the strength and integrity of the ball stud 1000b.

As described previous, because each through-holes 1622₁, 1622₂, . . . 1622ₘ of the first cluster 1620 of through-holes 1622 is formed from the hollow center 1600 to the outer surface of the head 1400 of the ball stud 1000b, each opening 1624₁, 1624₂, . . . 1624ₙ at the outer surface of the head 1400 of the ball stud 1000b is in fluid communication with the opening 1601 at the first end 1001 of the ball stud 1000b. To this end, a fluid, such as a lubricating fluid, may enter the sealed ball-and-socket joint 2400 utilizing the hollow center 1600 of the ball stud 1000b and the first cluster 1620 of through-holes 1622.

Similarly, each of the second cluster 1640 openings 1644₁, 1644₂, . . . 1644ₘ at the outer surface of the shank 1200 of the ball stud 1000b is in fluid communication with the opening 1601 at the first end 1001 of the ball stud 1000b. When the hollow center 1600 of the ball stud 1000b is utilized to direct a fluid, such as a lubricating fluid, to the sealed ball-and-socket joint 2400, the fluid may also travel to the second cluster 1640 openings 1644₁, 1644₂, . . . 1644ₘ at the outer surface of the shank 1200. It may be desirous to deliver the fluid through these opening 1644 as well. However, if it is not desirous, these openings 1644 may be clogged or covered or gravity or fluid mechanics can aid in directing the majority of the fluid to the openings 1624 at the head 1400 of the ball stud 1000b.

A gross weight W_{1000b} of the ball stud 1000b may be approximated by Equation 6:

W_{1000b}=W_{1000H}−(WR₁₆₂₀+WR₁₆₄₀) (6)

In Equation 6, W_{1000H} represents the adjusted weight of a ball stud with a hollow center 1600 but without a first cluster 1620 of through-holes 1622 or a second cluster 1640 of through-holes 1642, as calculated utilizing Equation 2, WR₁₆₂₀ represents the weight reduction attributed to the first cluster 1620 of through-holes 1622, and WR₁₆₄₀ represents the weight reduction attributed to the second cluster 1640 of through-holes 1642. The weight reduction W_{R1620} attributed to the first cluster 1620 of through-holes 1622 and the weight reduction WR₁₆₄₀ attributed to the second cluster 1640 of through-holes 1642 may be approximated by Equations 7 and 8, respectively:

WR₁₆₂₀=n*γ_{M}*AVG(L₁₆₂₂)*π*(0.5*D₁₆₂₂)² (7)

WR₁₆₄₀=m*γ_{M}*AVG(L₁₆₄₂)*π*(0.5*D₁₆₄₂)² (8)

In some examples, the ball stud 1000 is implemented utilizing a material having a unit weight of approximately 0.284 pounds per cubic inch, γ_{M}≈0.284 lb/in³, and is implemented as having an adjusted weight W_{1000H}≈4.06 lb. (as demonstrated in the previously described example), an AVG(L₁₆₂₂)≈0.95-inches, an AVG(L₁₆₄₂)≈0.65-inches, a D₁₆₂₂≈D₁₆₄₂≈0.177-inches, an integer n=50, and an integer m=32. In these examples, Equation 7 demonstrates that the weight reduction WR₁₆₂₀ attributed to the first cluster 1620 of through-holes 1622 approximates 0.33-pounds. Equation 8 then demonstrates that the weight reduction WR₁₆₄₀ attributed to the second cluster 1640 of through-holes 1642 approximates 0.15-pounds. Equation 6 then demonstrates that the gross weight W_{1000b} approximates 3.58-pounds. This represents a gross weight reduction of more than twenty-one percent (0.97-pounds) in the ball stud 1000b when compared to the blank solid weight W_{1000S}. Notably, as discussed above, both the material and the dimensions of the ball stud 1000b may vary without deviating from the scope of the disclosure. Accordingly, the unit weight γ_{M}, the weight reduction WR₁₆₂₀ attributed to the first cluster 1620 of through-holes 1622, the weight reduction WR₁₆₄₀ attributed to the second cluster 1640 of through-holes 1642, the gross weight W_{1000b}, and the gross weight reduction may vary from what is discussed here without deviating from the scope of this disclosure.

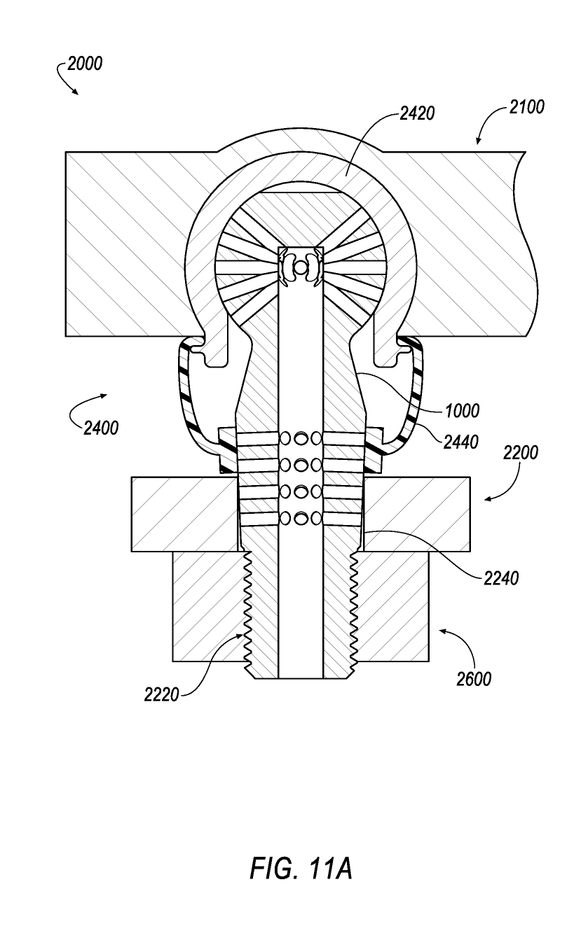

Referring to FIG. 9, a method 900 of forming a ball stud 1000 is disclosed. At step 920, the method includes cold-forming a blank solid ball stud. The blank may be produced through a cold-formed headed process. This process is volume-specific with a quantity of material being shaped to near net shape of the ball stud conforming to the requirements for which it will be utilized. Following the step 920, the blank resembles the shape desired for the final ball stud. If the ball stud 1000 is implemented with a hollow center 1600, then the hollow center 1600 is partially formed at step 920. At step 940, the method 900 includes heat-treating the blank. At this step, the blank undergoes either a through-hardening process or an induction heat-treating process. At step 960, the method 900 includes roll-threading the blank to form the threaded end 1220 of the shank 1200. At step 980, the method 900 includes turning the blank to finish the ball stud 1000. Referring to FIG. 10, the step 980 includes sub-steps 982, 984, 986. At sub-step 982, step 980 of method 900 includes finish-turning the blank to application-specific specifications. At sub-step 982, dimensions of the ball stud 1000, as discussed previously, are specifically formed to meet the specifications for the particular ball stud 1000 being manufactured. At sub-step 984, the step 980 of method 900 includes completing the hollow center 1600. A drilling process may be utilized to complete the hollow center 1600. At sub-step 986, the step 980 of the method includes drill-processing the blank to form the through-holes 1622, 1642.

Referring to FIG. 11A, a portion of an automotive system 2000 (e.g., a suspension system or a steering system) utilizing the ball stud 1000b of this disclosure is illustrated. While FIG. 11A illustrates a utilization of ball stud 1000b, the ball stud 1000a could be substituted into the automotive system 2000 of FIG. 11A. The automotive system 2000 includes a first component 2100 (e.g., a tie rod), a second component 2200 (e.g., a steering knuckle), and a ball-and-socket joint 2400. The joint casing 2420, or socket, resides within the first component 2100. The head 1400 of the ball stud 1000 fits within the joint casing 2420 of the ball-and-socket joint 2400. The ball-and-socket joint also includes a seal 2440 that encloses the head 1400 of the ball stud 1000 within the joint casing 2420. The threaded end 1220 of the shank 1200 of the ball stud 1000 passes through an eyelet 2240 of the second component 2200 such that the second component 2200 engages the tapered portion 1240 of the shank 1200. A nut 2600 (e.g., a castle nut with a cotter pin) threads onto a threaded end 1220 of the shank 1200. In this fashion, the shank 1200 of the ball stud 1000 is fastened to second component 2200 and the head 1400 of the ball stud 1000 operates as the ball of a ball-socket-joint 2400 at the first component 2100.

Referring to FIG. 11B, a portion of an automotive system 2000 (e.g., a suspension system or a steering system) utilizing the ball stud 1000b of this disclosure is illustrated. While FIG. 11B illustrates a utilization of ball stud 1000b, the ball stud 1000a could be substituted into the automotive system 2000 of FIG. 11B. The automotive system 2000 includes a first component 2100 (e.g., a tie rod), a second component 2200 (e.g., a steering knuckle), and a ball-and-socket joint 2400. The joint casing 2420, or socket, resides within the first component 2100. The head 1400 of the ball stud 1000 fits within the joint casing 2420 of the ball-and-socket joint 2400. The ball-and-socket joint also includes a seal 2440 that encloses the head 1400 of the ball stud 1000 within the joint casing 2420. The threaded end 1220 of the shank 1200 of the ball stud 1000 threads into a threaded hole 2220 of the second component 2200. In this fashion, the shank 1200 of the ball stud 1000 is fastened to second component 2200 and the head 1400 of the ball stud 1000 operates as the ball of a ball-socket-joint 2400 at the first component 2100.

A number of implementations have been described. Nevertheless, it will be understood that various modifications may be made without departing from the spirit and scope of the disclosure. Accordingly, other implementations are within the scope of the following claims.

What is claimed is:

1. A ball stud, comprising:
a shank;
a head formed integrally with the shank or as a single-piece construction with the shank;
a hollow center extending at least partially through the shank and at least partially into the head;
a first cluster of radial holes formed in the head; and
a second cluster of radial holes formed in the shank.

2. The ball stud of claim 1, wherein the shank is substantially cylindrical.

3. The ball stud of claim 2, wherein the shank comprises:
a tapered portion; and
a threaded end.

4. The ball stud of claim 1, wherein the head is substantially spherical.

5. The ball stud of claim 4, wherein the head comprises a flat end.

6. The ball stud of claim 1, wherein the radial holes of the second cluster of radial holes are formed with equal spacing around the full circumference of the shank.

7. The ball stud of claim 6, wherein the second cluster of radial holes comprises thirty-two through-holes.

8. The ball stud of claim 1, wherein the first cluster of radial holes comprises fifty through-holes.

9. A method of manufacturing a ball stud, comprising:
cold-forming a blank;
heat-treating the blank;
roll-threading the blank to form a threaded end; and
turning the blank to finish the ball stud,
wherein the ball stud comprises a shank, a head formed integrally with the shank or as a single-piece construction with the shank, and a hollow center extending at least partially through the shank and at least partially into the head, wherein the shank, the head, and the hollow center begin taking a shape during the cold-forming step, and wherein the turning step comprises drill-processing the blank to form a first cluster of radial through-holes formed into the head and a second cluster of radial through-holes formed into the shank.

10. The method of claim 9, wherein the shank is substantially cylindrical.

11. The method of claim 10, wherein the shank comprises:
a tapered portion; and
a threaded end.

12. The method of claim 9, wherein the head is substantially spherical.

13. The method of claim 12, wherein the head comprises a flat end.

14. The method of claim 9, wherein radial through-holes of the second cluster of radial through-holes are formed with equal spacing around the full circumference of the shank.

15. The method of claim 14, wherein the second cluster of radial through-holes comprises thirty-two through-holes.

16. The method of claim 9, wherein the first cluster of radial through-holes comprises fifty through-holes.

17. A ball stud, comprising:
a shank;
a head formed integrally with the shank or as a single-piece construction with the shank;
a hollow center extending at least partially through the shank and at least partially into the head; and
a plurality of weight-reducing cylindrical holes formed into the ball stud.

18. The ball stud of claim 17, wherein the shank is substantially cylindrical.

19. The ball stud of claim 18, wherein the shank comprises:
a tapered portion; and
a threaded end.

20. The ball stud of claim 17, wherein the head is substantially spherical.

21. The ball stud of claim 20, wherein the head comprises a flat end.

22. The ball stud of claim 17, wherein the plurality of weight-reducing cylindrical holes comprises holes formed radially into the shank.

23. The ball stud of claim 17, wherein the plurality of weight-reducing cylindrical holes comprises holes formed radially into the head.
